(19) United States
(12) Patent Application Publication
(10) Pub. No.: US 2008/0126879 A1
(43) Pub. Date: May 29, 2008

(54) Method and system for a reliable kernel core dump on multiple partitioned platform

(76) Inventors: Rajeev Tiwari, Bangalore (IN); Basheer Ahamed, Mansoor Ahamed, Bangalore (IN); Padma Apparao, Portland, OR (US)

Correspondence Address: INTEL/BLAKELY, 1279 OAKMEAD PARKWAY, SUNNYVALE, CA, 94085-4040, US

(21) Appl. No.: 11/529,030

(22) Filed: Sep. 27, 2006

(51) Int. Cl. G06F 11/07; G06F 12/16; G06F 9/54

(52) U.S. Cl. 714/46; 711/162; 719/319; 711/E12.103; 714/E11.021

(57) ABSTRACT

A method and system for generating and obtaining reliable core dump from a multiple partitioned platform is described. The method generated a system core dump by a first operating system in a first partition, in response to detecting a predetermined event. The core dump may be stored in a shared memory accessible to a plurality of operating systems. An interrupt is sent when a core dump is generated. Upon a detection of the interrupt, the core dump may be accessed by a second operating system in a second partition for analysis. Other embodiments of inventions are described in the claims.

### FIELD

An embodiment of the invention relates to generating core dump on a multiple partitioned platform.

### BACKGROUND

A core dump represents a snapshot of a computer system at a specific time. When a problem occurs in the computer system, analyzing a core dump is a useful method in determining the causes of the problem. The core dump is generally used to debug a program or a system that has terminated abnormally, for example, a system crash. The core dumpt typically refers to a file containing a memory image of a particular process, or the memory images of parts of the address space of that process, complete, unstructured state of the dumped memory regions

The core dump provides information such as the memory usage or the processes running at the time the problem arises in the computer system. The method of troubleshooting using the core dump may be described in two general steps. First, a core dump is generated. Second, the core dump is either stored on a specific memory space managed by the core dump device or the core dump is transferred out of the computer system to be analyzed.

Generally, a dumping device driver is installed on a computer system and managed by an operating system running on that computer system. When a problem occurs, the dumping device driver gathers information on the computer system and generates a core dump. More specifically, the core dump is related to the operating system and the processes running on that operating system at the time the system failure occurs. When a core dump is generated, it is usually stored in a memory space allocated for that operating system.

When a problem occurs at a computer system, the dumping device may be corrupted by the problem that causes the computer system failure. The corrupted dumping device may generate unreliable kernel images such a tainted kernel images or no images at all. Examples of a tainted kernel image may be a partial kernel image or a kernel image that contains incorrect core dump information. A tainted kernel image or a complete lack of kernel image does not assist in troubleshooting a problematic computer system.

Another method in obtaining a core dump is to use a network based dump tools. This method uses a dumping device recites remotely on another system different from the problem system. When a problem occurs on a computer system and requires a core dump, a remote dumping device may not be corrupted. Therefore, a remote dumping device may generate a more reliable core dump than a dumping device reciting on the same problem system.

However, depending on the problem system, the size of a core dump may be extremely large. For example, a core dump of a high end server may require 16 GB of storage space. Bandwidth may be an issue when transferring a core dump of this size over a network off the problem system. In addition, the network may not be reliable enough to transmit the core dump of this size.

### BRIEF DESCRIPTION OF DRAWINGS

Various embodiments are illustrated by way of example and not by way of limitation in the figures of the accompanying drawings in which like references indicate similar elements. It should be noted that references to “an,” “one,” or “various” embodiments in this disclosure are not necessarily to the same embodiment, and such references mean at least one.

FIG. 1A depicts a computer system having multiple operating systems according to an embodiment of the invention.

FIG. 1B describes the general booting process according to an embodiment of the invention.

FIG. 2 depicts a main partition and a sequestered partition according to an embodiment of the invention.

FIG. 3A depicts a main partition and a sequestered partition sharing a shared memory space with overlapping memory allocation according to an embodiment of the invention.

FIG. 3B depicts a main partition and a sequestered partition sharing a shared memory space with non-overlapping memory allocation according to an embodiment of the invention.

FIG. 4A illustrates a mechanism for obtaining a reliable core dump according to an embodiment of the invention.

FIG. 4B describes the operations in which a reliable core dump may be generated and obtained according to an embodiment of the invention.

FIG. 5 illustrates a path in which a core dump may be moved before it is analyzed according to an embodiment of the invention.

FIG. 6 illustrates a system in which a core dump device may be utilized according to an embodiment of the invention.

### DETAILED DESCRIPTION

A method for providing a reliable kernel core dump on a multi-core platform is described herein. A person of ordinary skill in the pertinent art, upon reading the present disclosure, will recognize that various novel aspects and features of the present invention can implemented independently or in any suitable combination, and further, that the disclosed embodiments are merely illustrative and not meant to be limiting.

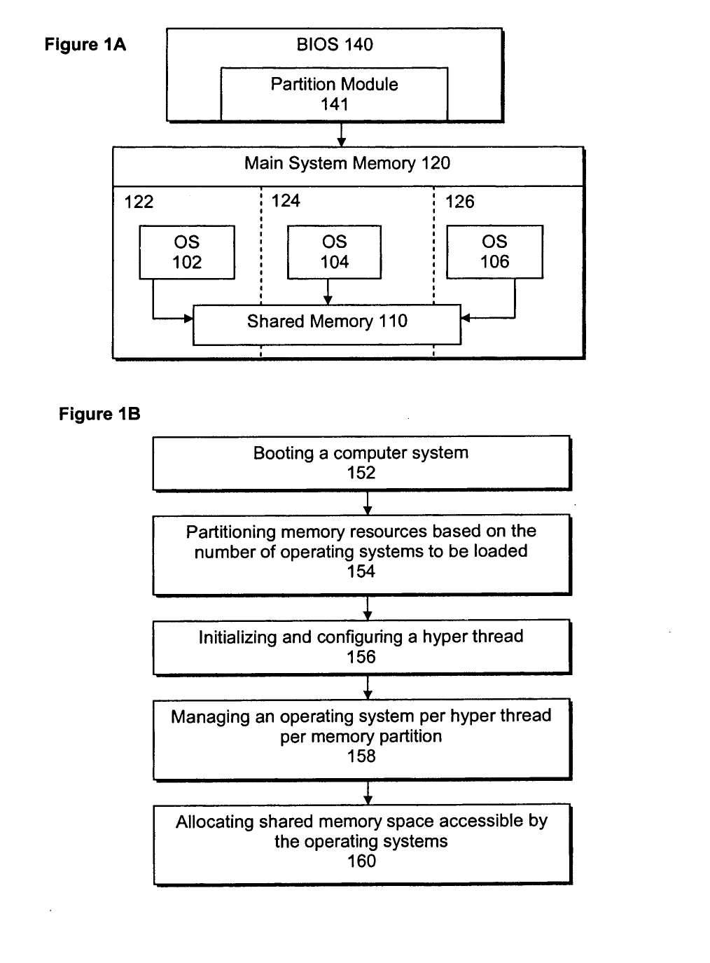

FIG. 1A depicts a computer system having multiple operating systems according to an embodiment of the invention. As shown in FIG. 1A, a computer system 100 includes operating systems 102, 104 and 106. These operating systems may be different instances of the same operating system each run on separate threads, or different instances of different operating systems. For example, the operating systems 102, 104 and 106 may be three instances of Linux each managed by a thread. Another example would be a computer system 100 including a Linux, an UNIX, and a Windows XP. In one embodiment of the invention, these multiple operating systems have access to a shared memory 110. The shared memory 110 may be a portion of a main system memory, as shown in FIG. 1, or it may be a different system memory separate from the main system memory (not shown in FIG. 1A).

During a computer system boot up process, each instance of an operating system is loaded into a partition of the main system memory 120. As shown in FIG. 1A, the operating system 102 is loaded into a partition 122, the loaded into a partition 124, and the operating system 106 is loaded into a partition space 126.

The partitioning of these separate memory spaces may be done by a firmware 140. In one embodiment of the invention, the firmware may be stored in a basic input/out system (BIOS). The BIOS is generally responsible for initializing and configuring system hardware and software resources.

An example of the firmware 140 would be a PRL firmware currently used by the Intel™ 915G chipset. PRL firmware is a modified version of Tiano™ firmware. A Tiano™ firmware is an example of an Extensible Firmware Interface (EFI). The firmware 140 such as the PRL firmware divides the system resource during the boot phase. Such division of memory space may be referred to as “soft partitioning.”

FIG. 1B describes the general booting process according to an embodiment of the invention. As shown in FIG. 1B, during a computer system booting process 150, the computer system is booted based on the instruction sets and the firmware in the system BIOS (operation 152). In this example, the firmware 140 divided hardware resources such as a main system memory into multiple partitions based on the number of instances of operating systems to be loaded (operation 154). Each instance of an operating system may be managed by a thread such as a hyper thread. Therefore, in operation 156, a hyper thread may be initiated and configured for each instance of operating system to be loaded. After the hyper threads are properly initiated and configured, the multiple operating systems may be loaded into each of the partitioned memory space (operation 158). One hyper thread may be associated with one instance of the operating system.

Dividing main system memory into multiple partitions for multiple operating systems may include allocating memory space to be used by the corresponding operating system (operation 160). The allocation of separate memory space may be accomplished pursuant to the soft partitioning process 154 (e.g. operation 160) or the allocation may be accomplished during the soft partitioning process 154. Furthermore, a shared memory may be allocated to be accessible by the multiple operating systems (operation 162).

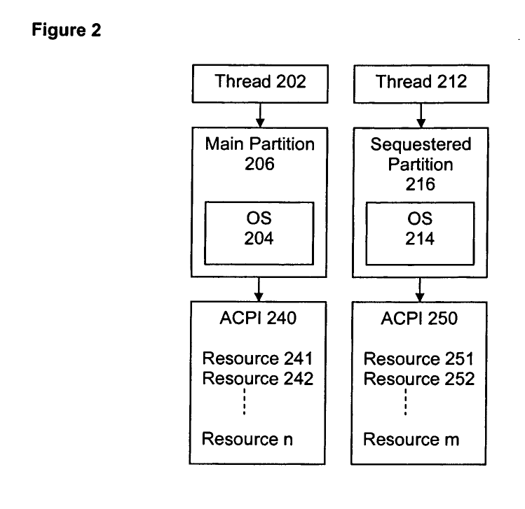

FIG. 2 depicts a main partition and a sequestered partition according to an embodiment of the invention. As shown in FIG. 2, two operating systems are to be loaded in a computer system. In this example, a main system memory is divided into two partitions. First, thread 202 manages an operating system 204. The operating system 204 is loaded into a main partition 206. Second, thread 212 manages an operating system 214. The operating system 214 is loaded into a sequestered partition 216.

In one embodiment of the invention, each thread maintains an advanced configuration and power interface (ACPI) table. Each table includes a list of resources that will be initiated, configured and maintained by each thread. As shown in FIG. 2, the thread 202 maintains an ACPI table 240 and the thread 212 maintains an ACPI table 250. The ACPI table 240 includes a list of resources 241, 242, . . . , n, and the ACPI table 250 includes a list of resources 251, 252, . . . , m. Examples of resources may be a keyboard, a display, a storage device, and a memory controller.

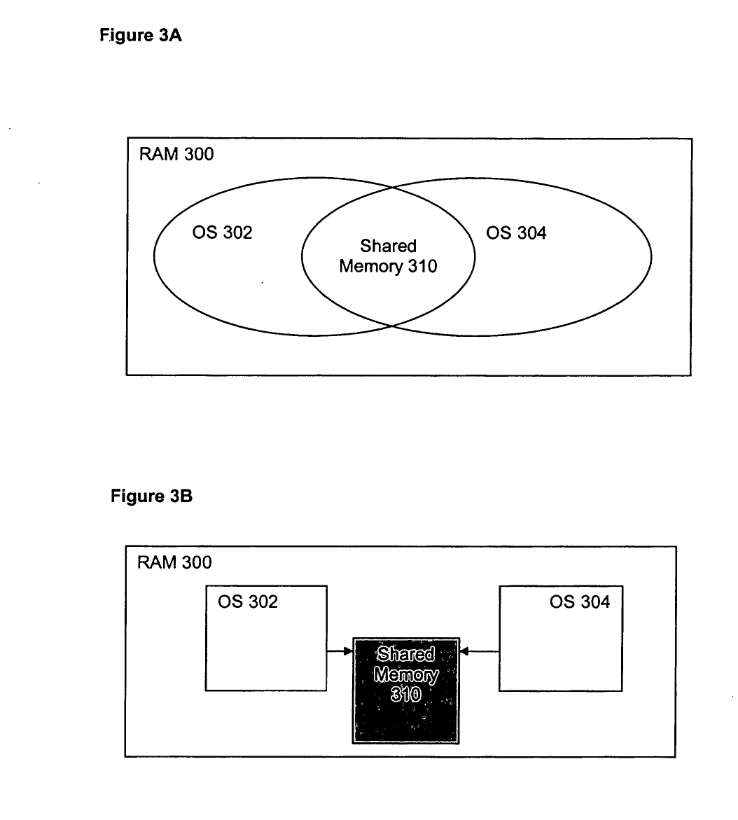

FIG. 3A depicts a main partition and a sequestered partition sharing a shared memory space with overlapping memory allocation according to an embodiment of the invention. Multiple operating systems may be soft partitioned so that they share a common memory space. In this example, two partitions are divided store two instances of the operating systems. As shown in FIG. 3, the main partition with operating system 302 occupies a portion in a main system memory such as a random access memory (RAM) 300. The sequestered partition with operating system 304 also occupies another portion in the RAM 300 such that there may be an overlap of memory space between the main partition 302 and the sequestered partition 304. Shared memory 310 may be accessible by both the main partition 302 and the sequestered partition 304.

FIG. 3B depicts a main partition and a sequestered partition sharing a shared memory space with non-overlapping memory allocation according to an embodiment of the invention. As shown in FIG. 3B, a shared memory space 350 is not allocated as part of a main partition 302 or as a part of a sequestered partition 304. In one embodiment of the invention, the shared memory space 350 may reside on the same system memory RAM 300 as the main partition 302 and the sequestered partition 304. In another embodiment of the invention, the shared memory space 350 may reside on another memory device (not shown in FIG. 3B).

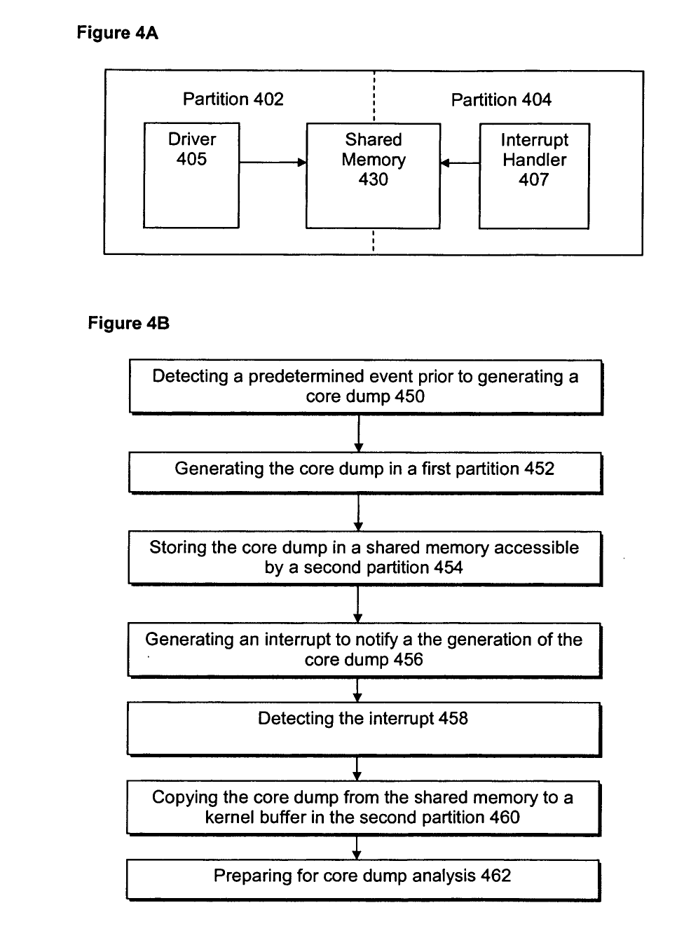

FIG. 4A illustrates a mechanism for obtaining a reliable core dump according to an embodiment of the invention. FIG. A module 405 may be installed as part of a main partition 402 to detect a predetermined event prior to the generation of a core dump. The predetermined event may be a kernel failure or may be an event triggered by a user. When the kernel failure occurs, an interrupt may be sent. In this example, the module 405 may detect the interrupt and start to prepare a core dump. In another example, the user may force a core dump by entering a combination of keys. For example, the user may enter Ctrl-Alt-D to trigger a core dump. The module 405 may detect this combination of key strokes and start to prepare a core dump.

After a core dump is generated, the module 405 stores the core dump in a shared memory 430. As described above in FIG. 3A and 3B, the shared memory 430 may be allocated as part of the main partition and the sequestered partition, or as a separate memory space not associated with the main partition and the sequestered partition. For the purpose of illustrating the three components in this embodiment of the invention, FIG. 4A depicts merely a shared memory 430 that is allocated as part of the main partition and the sequestered partition.

An interrupt handler 407 may be installed as part of a sequestered partition 404. The interrupt handler 407 may be used detect an interrupt sent by the operating system running in the main partition 402 when a core dump is generated in the main partition 402. In one embodiment of the invention, an interprocessor bridge (IPB) library may be used to communicate between the two partitions.

FIG. 4B describes the operations in which a reliable core dump may be generated and obtained according to an embodiment of the invention. Operation 450 detects a predetermined event prior to generating a core dump. As discussed above, a predetermined event may be an interrupt sent by a kernel when a failure occurs. Another predetermined event may be a signal submitted by a user to trigger a core dump. Upon the detection of a predetermined event, a core dump may be generated in the first partition (operation 452). Core dump tools such as Linux Kernel Crash Dump (LKCD) may be used to generate core dumps.

After the core dump is generated, it is stored in a shared memory (operation 454). The shared memory is accessible by a second partition. Then an interrupt is sent and to notify the generation of the core dump in the first partition (operation 456). In operation 458, the interrupt is detected by the second partition. Upon the detection of the interrupt, the core dump is copied from the shared memory to a kernel buffer in the second partition (operation 460). In operation 462, the core dump is ready for analysis. In one embodiment of the invention, a user memory space application from the second partition may copy the core dump from the kernel buffer into a user memory space. In one embodiment of the invention, a memory based character driver may be used to extract the core dump from the shared memory and copy it to the user memory space.

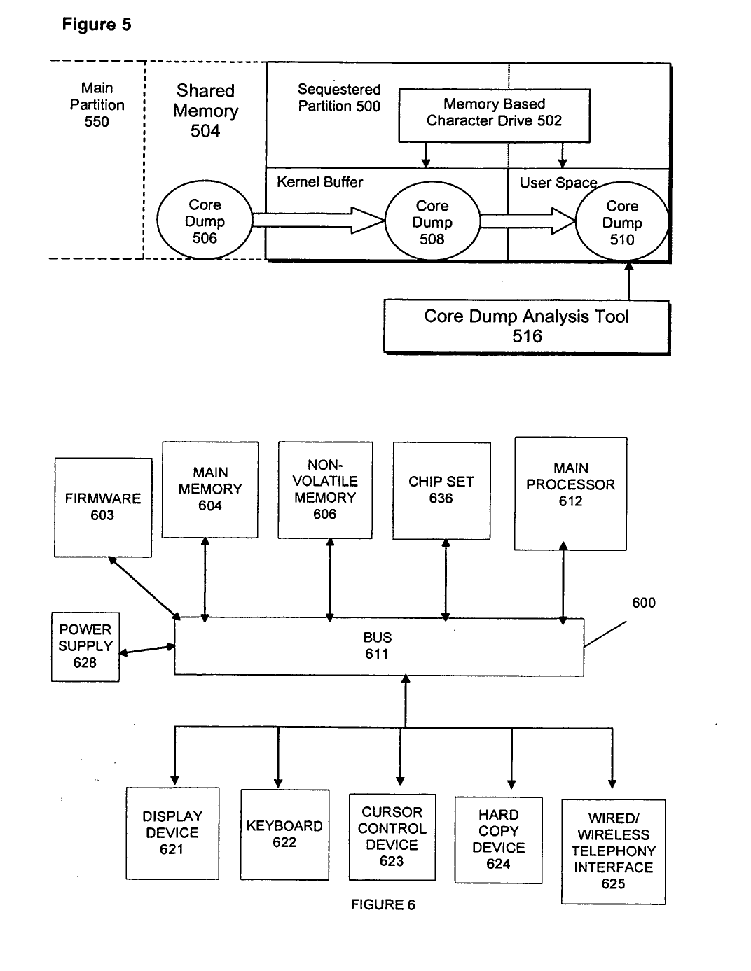

FIG. 5 illustrates a path in which a core dump may be moved before it is analyzed according to an embodiment of the invention. A core dump 506 represents the core dump generated pursuant to a detection of a predetermined event such as a system failure or an input from a user. The core dump 506 may be stored in a shared memory 504. After an interrupt is sent by a main partition 550 and detected by a sequestered partition 520, the core dump 506 may be copied to a kernel buffer 512, as shown by a core dump 508. In one embodiment of the invention, a memory based character driver 502 may be used to extract the core dump 508 from the kernel buffer 512 and copy the core dump 508 to a user space 514. A core dump analysis tool 516 may be used to analyze a core dump 510 after it is copied into the user space 514.

It should be noted that a system failure may occur in the sequestered partition instead of the main partition as discussed in the examples previous. A person skilled in the art would appreciate that in an event a system failure occurs in the sequestered partition or in a partition other than the main partition, a core dump generated on the failed partition may be retrieved in the method described above. For example, if a core dump is generated on the sequestered partition due to a failure on this partition or an event triggered by a user, the core dump may be stored on the shared memory and accessible by the main partition.

FIG. 6 illustrates a block diagram of an example computer system in which a core dump device may be utilized according to an embodiment of the invention. In one embodiment, computer system 600 comprises a communication mechanism or bus 611 for communicating information, and an integrated circuit component such as a main processing unit 612 coupled with bus 611 for processing information. One or more of the components or devices in the computer system 600 such as the main processing unit 612 or a chip set 636 may use an embodiment of the polarization sheet. The main processing unit 612 may consist of one or more processor cores working together as a unit.

Computer system 600 further comprises a random access memory (RAM) or other dynamic storage device 604 (referred to as main memory) coupled to bus 611 for storing inf6ormation and instructions to be executed by main processing unit 612. Main memory 604 also may be used for storing temporary variables or other intermediate information during execution of instructions by main processing unit 612.

Firmware 603 may be a combination of software and hardware, such as Electronically Programmable Read-Only Memory (EPROM) that has the operations for the routine recorded on the EPROM. The firmware 603 may embed foundation code, basic input/output system code (BIOS), or other similar code. The firmware 603 may make it possible for the computer system 600 to boot itself.

Computer system 600 also comprises a read-only memory (ROM) and/or other static storage device 606 coupled to bus 611 for storing static information and instructions for main processing unit 612. The static storage device 606 may store OS level and application level software.

Computer system 600 may further be coupled to or have an integral display device 621, such as a cathode ray tube (CRT) or liquid crystal display (LCD), coupled to bus 611 for displaying information to a computer user. A chipset may interface with the display device 621.

An alphanumeric input device (keyboard) 622, including alphanumeric and other keys, may also be coupled to bus 611 for communicating information and command selections to main processing unit 612. An additional user input device is cursor control device 623, such as a mouse, trackball, trackpad, stylus, or cursor direction keys, coupled to bus 611 for communicating direction information and command selections to main processing unit 612, and for controlling cursor movement on a display device 621. A chipset may interface with the input output devices. Similarly, devices capable of making a hardcopy 624 of a file, such as a printer, scanner, copy machine, etc. may also interact with the input output chipset and bus 611.

Another device that may be coupled to bus 611 is a power supply such as a battery and Alternating Current adapter circuit. Furthermore, a sound recording and playback device, such as a speaker and/or microphone (not shown) may optionally be coupled to bus 611 for audio interfacing with computer system 600. Another device that may be coupled to bus 611 is a wireless communication module 625. The wireless communication module 625 may employ a Wireless Application Protocol to establish a wireless communication channel. The wireless communication module 625 may implement a wireless networking standard such as Institute of Electrical and Electronics Engineers (IEEE) 802.11 standard, IEEE std. 802.11-1999, published by IEEE in 1999.

In one embodiment, the software used to facilitate the above routines or fabricate the above components can be embedded onto a machine-readable medium. A machine-readable medium includes any mechanism that provides (i.e., stores and/or transmits) information in a form accessible by a machine (e.g., a computer, network device, personal digital assistant, manufacturing tool, any device with a set of one or more processors, etc.). For example, a machine-readable medium includes recordable/non-recordable media (e.g., read only memory (ROM) including firmware; random access memory (RAM); magnetic disk storage media; optical storage media; flash memory devices; etc.), as well as electrical, optical, acoustical or other form of propagated signals (e.g., carrier waves, infrared signals, digital signals, etc.); etc.

Although the invention has been described in detail hereinabove, it should be appreciated that many variations and/or modifications and/or alternative embodiments of the basic inventive concepts taught herein that may appear to those skilled in the pertinent art will still fall within the spirit and scope of the present invention as defined in the appended claims.

What is claimed is:

1. The method comprising:
generating a system core dump in response to detecting a predetermined event, the system core dump represent state information associated with a first operating system;
storing the system core dump in a shared memory space accessible by a second operating system;
generating an interrupt to indicate the generation of the system core dump; and
accessing the system core dump by the second operating system in response to detecting the interrupt.

2. The method of claim 1, wherein the predetermined event includes a system failure.

3. The method of claim 1, wherein the predetermined event includes a user input request.

4. The method of claim 1, wherein accessing the system core dump further comprising:
copying the system core dump onto a kernel buffer accessible to the second operating system.

5. The method of claim 4 further comprising:
copying the system core dump from the kernel buffer to a user space.

6. The method of claim 1 wherein the first operating system is managed by a first thread and the second operating system is managed by a second thread.

7. A system comprising:
a first memory partition to execute a first operating system;
a second memory partition to execute a second operating system;
a first driver from the first operating system to store a system core dump in a shared memory accessible by the second operating system;
an interrupt handler from the second operating system to detect an interrupt in response to storing the system core dump; and
a second driver from the second operating system to access the system core dump.

8. The system of claim 7, wherein the system core dump is generated in response to a predetermined event, the predetermined event includes a system failure and a user initiated signal.

9. The system of claim 7, wherein the shared memory includes an overlapping address space common to the first memory partition and the second memory partition.

10. The system of claim 7 further comprising:
an interprocessor bridge (IPB) to communicate between the first operating system and the second operating system.

11. The system of claim 7 further comprising:
a first thread to manage the first operating system; and
a second thread to manage the second operating system.

12. The system of claim 7 wherein the second driver further copying the system core dump to a user space in preparation for core dump analyzing.

13. A system comprising:
a processor;
a plurality of operating systems;
a basic input/output system (BIOS), the BIOS includes a firmware module to partition a memory into a plurality of memory spaces for the plurality of operating systems;
a first driver to store a system core dump generated from a first partition in a shared memory accessible by the plurality of operating systems;
a second driver to access the system core dump from a second partition; and
a system core dump analysis tool to analyze the system core dump.

14. The system of claim 13 further comprising:
a core dump generator to generate the system core dump in response to a predetermined event.

15. The system of claim 13, wherein the predetermined event includes a system failure in the first partition.

16. The system of claim 13, wherein the predetermined event includes a forced core dump triggered by a user.

17. The system of claim 13 further comprising:
an interrupt handler to detect an interrupt to notify the generation of the system core dump; and
a memory based character driver to extract the system core dump from a kernel buffer.

18. The machine accessible medium that provides instructions that, when executed by a processor, causes the processor to:
generate a system core dump by a first operating system in response to detecting a predetermined event;
store the system core dump in a shared memory space accessible by a second operating system;
generate an interrupt to indicate the generation of the system core dump; and
access the system core dump by the second operating system in response to detecting the interrupt.

19. The machine readable medium of claim 18, wherein the predetermined event includes a system failure.

20. The machine readable medium of claim 18, wherein the predetermined event includes a trigger by a user.

21. The machine readable medium of claim 18, wherein accessing the system core dump further comprising:
copying the system core dump onto a kernel buffer accessible by the second operating system.

22. The machine readable medium of claim 18 further comprising copying the system core dump from the kernel buffer to a user space.
